(19) United States
(12) Patent Application Publication
(10) Pub. No.: US 2026/0133510 A1
(43) Pub. Date: May 14, 2026

(54) ELECTROPHOTOGRAPHIC PHOTOSENSITIVE MEMBER, PROCESS CARTRIDGE, ELECTROPHOTOGRAPHIC APPARATUS, AND METHOD OF MANUFACTURING HYDROXYGALLIUM PHTHALOCYANINE CRYSTAL

(71) Applicant: CANON KABUSHIKI KAISHA, Tokyo (JP)

(72) Inventors: SHUHEI IWASAKI, Kanagawa (JP); KUNIHIKO SEKIDO, Shizuoka (JP); KOUSUKE KANAYAMA, Osaka (JP)

(21) Appl. No.: 19/434,518

(22) Filed: Dec. 29, 2025

Related U.S. Application Data
(63) Continuation of application No. PCT/JP2024/020909, filed on Jun. 7, 2024.

(30) Foreign Application Priority Data
Jun. 29, 2023 (JP) 2023-107194
Apr. 2, 2024 (JP) 2024-059708

(51) Int. Cl. G03G 5/06

(52) U.S. Cl. CPC G03G 5/0696; G03G 2215/00957; G03G 2215/00962; G03G 2221/183

(57) ABSTRACT

Provided is an electrophotographic photosensitive member including: a support; and a photosensitive layer, wherein the photosensitive layer contains a hydroxygallium phthalocyanine crystal, and wherein the hydroxygallium phthalocyanine crystal contains a compound A having a dipole moment magnitude of 3.6 D or more and an SP value SP_{A} of 11.5 (cal/cm³)^{1/2} or more, and a compound B having a dipole moment magnitude of more than 0 to 2.0 D and an SP value SP_{B} of 9.5 (cal/cm³)^{1/2} or less.

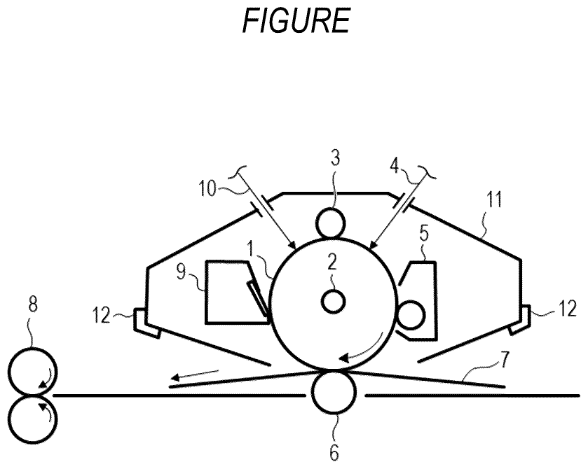

### CROSS-REFERENCE TO RELATED APPLICATIONS

This application is a Continuation of International Patent Application No. PCT/JP2024/020909, filed Jun. 7, 2024, which claims the benefit of Japanese Patent Application No. 2023-107194 filed Jun. 29, 2023, and Japanese Patent Application No. 2024-059708 filed Apr. 2, 2024, all of which are hereby incorporated by reference herein in their entirety.

### BACKGROUND

### Field of the Technology

The present disclosure relates to an electrophotographic photosensitive member, a process cartridge including the electrophotographic photosensitive member, and an electrophotographic apparatus including the electrophotographic photosensitive member. Further, the present disclosure relates to a method of manufacturing a hydroxygallium phthalocyanine crystal.

### Description of the Related Art

Currently, the oscillation wavelength of a semiconductor laser, which has been often used as image exposing unit in the electrophotographic field, is as long as 650 to 820 nm, and the development of an electrophotographic photosensitive member capable of reducing the absolute value of the potential of an exposed portion with respect to light having such long wavelength is underway.

A phthalocyanine pigment is effective as a charge-generating substance for an electrophotographic photosensitive member capable of reducing the absolute value of the potential of the exposed portion with respect to light up to such long-wavelength region.

In recent years, there has been an increasing demand for the image stability of an electrophotographic apparatus. In particular, along with an increase in speed of the electrophotographic apparatus, even in an electrophotographic apparatus for a high-speed printing process, there has been a stronger desire for an electrophotographic photosensitive member in which the potential of its exposed portion is stable without being affected by a fluctuation in humidity of an environment where the electrophotographic apparatus is used. As an electrophotographic photosensitive member showing little change in potential of the exposed portion with respect to a change in humidity, an electrophotographic photosensitive member using a V-type hydroxygallium phthalocyanine crystal as a charge-generating substance has been reported.

For example, in Japanese Patent Laid-Open No. H7-331107, there is a description of an electrophotographic photosensitive member using a hydroxygallium phthalocyanine crystal containing a polar organic solvent such as N,N-dimethylformamide.

In addition, in Japanese Patent Laid-Open No. 2016-161713, there is a description of an electrophotographic photosensitive member using a hydroxygallium phthalocyanine crystal containing N-methylformamide as a polar organic solvent.

The inventors of the present disclosure have investigated a change in potential of an exposed portion with respect to a fluctuation in humidity of an environment when the polar organic solvent-containing hydroxygallium phthalocyanine crystal containing described in each of Japanese Patent Laid-Open No. H7-331107 and Japanese Patent Laid-Open No. 2016-161713 is used as a charge-generating substance for an electrophotographic photosensitive member. As a result, while the absolute value of the potential of the exposed portion is low, it cannot be said that the crystal has enough performance to meet a higher requirement for environmental stability demanded in an electrophotographic apparatus for a high-speed printing process.

### SUMMARY

Accordingly, the present disclosure is directed to providing such an electrophotographic photosensitive member that even in an electrophotographic apparatus for a high-speed printing process, the absolute value of the potential of an exposed portion is low, and the potential of the exposed portion is highly stable without being affected by a fluctuation in humidity of an environment where the electrophotographic apparatus is used. The present disclosure is also directed to providing a process cartridge including the electrophotographic photosensitive member and an electrophotographic apparatus including the electrophotographic photosensitive member. The present disclosure is also directed to providing a method of manufacturing the following hydroxygallium phthalocyanine crystal: when the hydroxygallium phthalocyanine crystal is used as a charge-generating substance for an electrophotographic photosensitive member, the crystal can reduce the absolute value of the potential of the exposed portion of the electrophotographic photosensitive member; and the crystal can stabilize the potential of the exposed portion of the electrophotographic photosensitive member without being affected by a fluctuation in humidity of an environment where an electrophotographic apparatus including the electrophotographic photosensitive member is used.

The above-mentioned provision is achieved by the present disclosure described below. That is, according to one aspect of the present disclosure, there is provided an electrophotographic photosensitive member including: a support; and a photosensitive layer, wherein the photosensitive layer contains a hydroxygallium phthalocyanine crystal, and wherein the hydroxygallium phthalocyanine crystal contains: a compound A having a dipole moment magnitude of 3.6 D or more and an SP value SP_{A} of 11.5 (cal/cm³)^{1/2} or more; and a compound B having a dipole moment magnitude of more than 0 to 2.0 D and an SP value SP_{B} of 9.5 (cal/cm³)^{1/2} or less.

In addition, according to another aspect of the present disclosure, there is provided an electrophotographic photosensitive member including: a support; and a photosensitive layer, wherein the photosensitive layer contains a hydroxygallium phthalocyanine crystal, and wherein the hydroxygallium phthalocyanine crystal contains: at least one compound A selected from the group consisting of: N,N-dimethylformamide; and N-methylformamide; and at least one compound B selected from the group consisting of: toluene; ethyl acetate; and tetrahydrofuran.

In addition, according to another aspect of the present disclosure, there is provided a process cartridge including: the above-mentioned electrophotographic photosensitive member; and at least one unit selected from the group consisting of: charging unit; developing unit; and cleaning unit, the process cartridge integrally supporting the electrophotographic photosensitive member and the at least one unit, and being detachably attachable to a main body of an electrophotographic apparatus.

In addition, according to another aspect of the present disclosure, there is provided an electrophotographic apparatus including: the above-mentioned electrophotographic photosensitive member; exposing unit; charging unit; developing unit; and transferring unit.

In addition, according to another aspect of the present disclosure, there is provided a method of manufacturing a hydroxygallium phthalocyanine crystal, the method including: adding, to a hydroxygallium phthalocyanine pigment, a compound A having a dipole moment magnitude of 3.6 D or more and an SP value SP_{A} of 11.5 (cal/cm³)^{1/2} or more, and a compound B having a dipole moment magnitude of more than 0 to 2.0 D and an SP value SP_{B} of 9.5 (cal/cm³)^{1/2} or less; and subjecting the mixture to dispersion treatment by a wet milling system.

Features of the present disclosure will become apparent from the following description of embodiments with reference to the attached drawing.

### BRIEF DESCRIPTION OF THE DRAWINGS

FIGURE is a view for illustrating an example of the schematic configuration of an electrophotographic apparatus including a process cartridge including an electrophotographic photosensitive member according to the present disclosure.

### DESCRIPTION OF THE EMBODIMENTS

The present disclosure is described in detail below by way of an exemplary embodiment.

When a hydroxygallium phthalocyanine crystal is used as a charge-generating substance for an electrophotographic photosensitive member, the absolute value of the potential of the exposed portion of the electrophotographic photosensitive member can be reduced. Meanwhile, as a result of an investigation made by the inventors of the present disclosure, it has been found that, when the humidity of an environment where an electrophotographic apparatus is used increases, the absolute value of the potential of the exposed portion of the electrophotographic photosensitive member using the hydroxygallium phthalocyanine crystal as the charge-generating substance increases. The inventors of the present disclosure have conceived that this is because a water molecule in the environment adsorbs to a hydroxy group of a hydroxygallium phthalocyanine molecule for forming the hydroxygallium phthalocyanine crystal, to thereby reduce the separation efficiency of a charge pair generated by exposure.

In addition, the inventors of the present disclosure have compared a case in which the polar organic solvent-containing hydroxygallium phthalocyanine crystal described in Japanese Patent Laid-Open No. H7-331107 or Japanese Patent Laid-Open No. 2016-161713 is used as a charge-generating substance for an electrophotographic photosensitive member to the above-mentioned case in which the hydroxygallium phthalocyanine crystal is free of any polar organic solvent. As a result, it has been found that a change in potential of the exposed portion of the electrophotographic photosensitive member along with a change in environmental humidity is reduced by the hydroxygallium phthalocyanine crystal free of any polar organic solvent. When a related-art hydroxygallium phthalocyanine crystal containing only a highly polar compound is used as a charge-generating substance for an electrophotographic photosensitive member, the absolute value of the potential of the exposed portion of the electrophotographic photosensitive member can be reduced. Meanwhile, however, according to an investigation made by the inventors of the present disclosure, it has been found that in the electrophotographic photosensitive member using the hydroxygallium phthalocyanine crystal according to the related art, a change in potential of its exposed portion along with a change in environmental humidity cannot be sufficiently suppressed.

The highly polar compound is assumed to adsorb a water molecule instead of a hydroxy group of a hydroxygallium phthalocyanine molecule for forming the hydroxygallium phthalocyanine crystal to suppress a change in separation efficiency of a charge pair. However, even when the highly polar compound is incorporated into the hydroxygallium phthalocyanine crystal alone, an adsorbing effect on the water molecule may not be sufficiently exhibited. As a result, even when the hydroxygallium phthalocyanine crystal containing only the highly polar compound is used as a charge-generating substance for an electrophotographic photosensitive member, a change in potential of its exposed portion along with a change in environmental humidity cannot be sufficiently suppressed. Accordingly, it is conceivable that the related-art crystal has been insufficient to meet the recent higher requirement for the environmental stability of an electrophotographic apparatus.

As a result of repeated investigations made by the inventors of the present disclosure in order to solve the above-mentioned problem that occurred in the related art, the following has been found. That is, the problem in the related art can be solved when a hydroxygallium phthalocyanine crystal to be used in the photosensitive layer of an electrophotographic photosensitive member contains two or more kinds of compounds having specific physical properties. In other words, it has been found that the use of such hydroxygallium phthalocyanine crystal can reduce the absolute value of the potential of the exposed portion of the electrophotographic photosensitive member, and can significantly suppress a change in potential of the exposed portion along with a change in environmental humidity.

Based on the above-mentioned findings, the inventors of the present disclosure have completed the present disclosure described below. That is, an electrophotographic photosensitive member according to the present disclosure is an electrophotographic photosensitive member including: a support; and a photosensitive layer, the electrophotographic photosensitive member being characterized in that: the photosensitive layer contains a hydroxygallium phthalocyanine crystal; and the hydroxygallium phthalocyanine crystal contains: a compound A having a dipole moment magnitude of 3.6 D or more and an SP value SP_{A} of 11.5 (cal/cm³)^{1/2} or more; and a compound B having a dipole moment magnitude of more than 0 to 2.0 D and an SP value SP_{B} of 9.5 (cal/cm³)^{1/2} or less. In one aspect of the above-mentioned electrophotographic photosensitive member according to the present disclosure, the above-mentioned compound A is at least one selected from the group consisting of: N,N-dimethylformamide; and N-methylformamide. In addition, the above-mentioned compound B is at least one selected from the group consisting of: toluene; ethyl acetate; and tetrahydrofuran.

Further, a process cartridge according to the present disclosure is characterized in that the process cartridge integrally supports the above-mentioned electrophotographic photosensitive member, and at least one unit selected from the group consisting of: charging unit; developing unit; and cleaning unit, and is detachably attachable to the main body of an electrophotographic apparatus.

Further, an electrophotographic apparatus according to the present disclosure is characterized by including the above-mentioned electrophotographic photosensitive member, and exposing unit, charging unit, developing unit, and transferring unit.

Further, a method of manufacturing a hydroxygallium phthalocyanine crystal according to the present disclosure is characterized by including: adding, to a hydroxygallium phthalocyanine pigment, a compound A having a dipole moment magnitude of 3.6 D or more and an SP value SP_{A} of 11.5 (cal/cm³)^{1/2} or more, and a compound B having a dipole moment magnitude of more than 0 to 2.0 D and an SP value SP_{B} of 9.5 (cal/cm³)^{1/2} or less; and subjecting the mixture to dispersion treatment by a wet milling system.

The inventors of the present disclosure have conceived that the mechanism via which the above-mentioned technical problem can be solved with such configuration to be as described below.

As described above, when the related-art hydroxygallium phthalocyanine crystal containing only the highly polar compound is used as a charge-generating substance for an electrophotographic photosensitive member, a change in potential of its exposed portion along with a change in environmental humidity cannot be sufficiently suppressed. A possible reason for the foregoing is as described below. The highly polar compound is assumed to adsorb a water molecule instead of a hydroxy group of a hydroxygallium phthalocyanine molecule for forming the hydroxygallium phthalocyanine crystal to suppress a change in separation efficiency of a charge pair. However, even when the highly polar compound is incorporated into the hydroxygallium phthalocyanine crystal alone, an adsorbing effect on the water molecule may not be sufficiently exhibited.

In contrast to the foregoing, in the present disclosure, the compound A is incorporated as a highly polar compound, and at the same time, the compound B is incorporated as a lowly polar compound. Herein, the compound A is a compound having a dipole moment magnitude of 3.6 D or more and an SP value SP_{A} of 11.5 (cal/cm³)^{1/2} or more. In addition, the compound B is a compound having a dipole moment magnitude of more than 0 to 2.0 D and an SP value SP_{B} of 9.5 (cal/cm³)^{1/2} or less. When the compound B having a small dipole moment is mixed with the compound A, the compound B exhibits a suppressing effect on the intrusion of a water molecule and the adsorption thereof to a OH ligand. At the same time, the compound B has an SP value deviating from that of the compound A, and hence the compound B may localize the compound A closer to the OH ligand, to thereby causing the compound A to more significantly express the following effect: the water molecule is adsorbed thereto instead of the OH ligand.

It is conceivable from the foregoing that, in the present disclosure, a fluctuation in potential of the exposed portion of the electrophotographic photosensitive member due to the adsorption of the water molecule to the OH ligand can be suppressed more significantly as compared to the related-art case in which the highly polar compound is used alone.

Constituent elements according to the present disclosure are described in more detail below.

### [Electrophotographic Photosensitive Member]

The electrophotographic photosensitive member according to the present disclosure includes the support and the photosensitive layer.

An example of a method of manufacturing the electrophotographic photosensitive member according to the present disclosure is a method including: preparing coating liquids for the respective layers to be described later; applying the liquids in a desired layer order; and drying the liquids. In this case, examples of a method of applying each of the coating liquids include dip coating, spray coating, inkjet coating, roll coating, die coating, blade coating, curtain coating, wire bar coating, and ring coating. Of those, dip coating is preferred from the viewpoints of efficiency and productivity.

The support and the respective layers are described below.

### <Support>

In the present disclosure, the electrophotographic photosensitive member includes the support. In the present disclosure, the support is preferably an electroconductive support having electroconductivity. In addition, examples of the shape of the support include a cylindrical shape, a belt shape, and a sheet shape. Of those, a cylindrical support is preferred. In addition, the surface of the support may be subjected to, for example, electrochemical treatment such as anodic oxidation, blast treatment, or cutting treatment.

A metal, a resin, glass, or the like is preferred as a material for the support.

Examples of the metal include aluminum, iron, nickel, copper, gold, stainless steel, and an alloy thereof. Of those, an aluminum support using aluminum is preferred.

In addition, electroconductivity may be imparted to the resin or the glass by treatment, such as mixing or coating with an electroconductive material.

### <Electroconductive Layer>

In the present disclosure, an electroconductive layer may be arranged on the support. The arrangement of the electroconductive layer can conceal flaws and irregularities in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, a metal oxide is preferably used as the electroconductive particles, and in particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, each of the electroconductive particles may have a laminated construction having a core particle and a coating layer coating the particle. Examples of the core particle include titanium oxide, barium sulfate, and zinc oxide. The coating layer is, for example, a metal oxide such as tin oxide.

In addition, when the metal oxide is used as the electroconductive particles, their volume-average particle diameter is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The electroconductive layer has a thickness of preferably 1 to 50 μm, particularly preferably 3 to 40 km.

The electroconductive layer may be formed by preparing a coating liquid for an electroconductive layer containing the above-mentioned respective materials and a solvent, forming a coat thereof, and drying the coat. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. As a dispersion method for dispersing the electroconductive particles in the coating liquid for an electroconductive layer, there are given methods using a paint shaker, a sand mill, a ball mill, and a liquid collision-type high-speed disperser.

### <Undercoat Layer>

In the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron-transporting substance, a metal oxide, a metal, an electroconductive polymer, or the like for the purpose of improving electric characteristics. Of those, an electron-transporting substance or a metal oxide is preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

When the metal oxide is used, the surface of the metal oxide may be treated with a silane coupling agent or the like, or the metal oxide may be doped with an element, such as phosphorus or aluminum, or an oxide thereof.

In addition, the undercoat layer may further contain an additive.

The undercoat layer has a thickness of preferably 0.1 to 50 μm, more preferably 0.2 to 40 μm, particularly preferably 0.3 to 30 μm.

The undercoat layer may be formed by preparing a coating liquid for an undercoat layer containing the above-mentioned respective materials and a solvent, forming a coat thereof, and drying and/or curing the coat. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The electrophotographic photosensitive member according to the present disclosure includes the photosensitive layer on the support, the electroconductive layer, or the undercoat layer.

The photosensitive layer contains the hydroxygallium phthalocyanine crystal, and the hydroxygallium phthalocyanine crystal contains the compound A and the compound B. The compound A is a compound having a dipole moment magnitude of 3.6 D or more and an SP value SP_{A} of 11.5 (cal/cm³)^{1/2} or more. In addition, the compound B is a compound having a dipole moment magnitude of more than 0 to 2.0 D and an SP value SP_{B} of 9.5 (cal/cm³)^{1/2} or less.

In the present disclosure, the hydroxygallium phthalocyanine crystal containing the compound A and the compound B means a hydroxygallium phthalocyanine crystal having incorporated thereinto the compound A and the compound B.

A difference ΔSP defined by the following equation between the SP value SP_{A} of the compound A and the SP value SP_{B} of the compound B is preferably 2.5 or more, more preferably 3.0 or more.

$$Δ SP = S {P}_{A} - S {P}_{B}$$

In addition, the mass ratio b/a of the compound B to the compound A in the hydroxygallium phthalocyanine crystal is preferably 5.0 to 50%, more preferably 10 to 24%.

In addition, the mass ratio a/p of the compound A to the entirety of the hydroxygallium phthalocyanine crystal in the hydroxygallium phthalocyanine crystal is preferably 0.50 to 3.50%. In addition, the above-mentioned mass ratio a/p is more preferably 1.80 to 3.00%.

In addition, the mass ratio b/p of the compound B to the entirety of the hydroxygallium phthalocyanine crystal in the hydroxygallium phthalocyanine crystal is preferably 0.10 to 2.00%. In addition, the above-mentioned mass ratio b/p is more preferably 0.20 to 0.50%.

The mass ratio a/p of the compound A to the entirety of the hydroxygallium phthalocyanine crystal in the hydroxygallium phthalocyanine crystal and the mass ratio b/p of the compound B thereto may be measured by, for example, nuclear magnetic resonance (NMR). In addition, the mass ratio b/a of the compound B to the compound A in the hydroxygallium phthalocyanine crystal may be calculated by measuring the ratios a/p and b/p.

The compound A preferably has an amide group. In particular, the compound A is preferably at least one selected from the group consisting of: N,N-dimethylformamide; and N-methylformamide. For example, the compound A may be N,N-dimethylformamide or N-methylformamide. The compound A is more preferably N-methylformamide.

In addition, the compound B is preferably at least one selected from the group consisting of: toluene; ethyl acetate; and tetrahydrofuran. For example, the compound B may be toluene, ethyl acetate, or tetrahydrofuran. The compound B is more preferably toluene out of those compounds.

The photosensitive layers of electrophotographic photosensitive members are mainly classified into (1) a laminated photosensitive layer and (2) a single-layer photosensitive layer. (1) The laminated photosensitive layer includes a charge-generating layer containing a charge-generating substance and a charge-transporting layer containing a charge-transporting substance. (2) The single-layer photosensitive layer includes a photosensitive layer containing both of a charge-generating substance and a charge-transporting substance.

### (1) Laminated Photosensitive Layer

The laminated photosensitive layer includes the charge-generating layer and the charge-transporting layer.

### (1-1) Charge-Generating Layer

The charge-generating layer preferably contains the charge-generating substance and a binder resin.

In the present disclosure, the charge-generating substance contains a hydroxygallium phthalocyanine pigment.

Examples of any other charge-generating substance that may be used in the present disclosure include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment and a chlorogallium phthalocyanine pigment are preferred.

The hydroxygallium phthalocyanine pigment to be used as the charge-generating substance preferably has crystal particles each having a crystal form that shows peaks at Bragg angles 2θ of 7.4° 0.3° and 28.2°+0.3° in an X-ray diffraction spectrum using CuKα rays.

In addition, it is preferred that the crystal particle sizes of the hydroxygallium phthalocyanine pigment have a peak at 20 to 50 nm in a crystal particle size distribution measured by using small-angle X-ray scattering, and the full width at half maximum of the peak be 50 nm or less.

When a dispersant is used in milling treatment, the amount of the dispersant is preferably 10 to 50 times as large as that of the phthalocyanine pigment on a mass basis. In addition, a solvent to be used is, for example, an amide-based solvent, such as N,N-dimethylformamide, N,N-dimethylacetamide, N-methylformamide, N-methylacetamide, or N-methylpropionamide, a halogen-based solvent such as chloroform, an ether-based solvent such as tetrahydrofuran, or a sulfoxide-based solvent such as dimethyl sulfoxide. In addition, the amount of the solvent to be used is preferably 5 to 30 times as large as that of the phthalocyanine pigment on a mass basis.

In the present disclosure, a method of recovering and analyzing the compound A and the compound B from the electrophotographic photosensitive member is not particularly limited, but the compound A and the compound B may each be recovered and analyzed, for example, as described below. First, the photosensitive layer is dissolved by using an organic solvent or the like. Subsequently, the hydroxygallium phthalocyanine crystal is recovered by a known method such as centrifugation. The hydroxygallium phthalocyanine crystal thus recovered may be subjected to analysis.

A method for the qualitative analysis of each of the compound A and the compound B in the present disclosure is not particularly limited, but the qualitative analysis may be performed, for example, as described below. That is, the qualitative analysis may be easily performed by collating a spectrum obtained by a known structural analysis approach, such as pyrolysis gas chromatography-mass spectrometry or nuclear magnetic resonance (NMR) spectroscopy, with a known database.

In the present disclosure, whether or not the hydroxygallium phthalocyanine crystal contains the compound A and the compound B in itself may be determined by subjecting the resultant phthalocyanine crystal to NMR measurement under the following conditions and analyzing the resultant data.

### (NMR Measurement)

Used measurement apparatus: AVANCE III 500 manufactured by BRUKER
Measuring nucleus: ¹H
Solvent: deuterated sulfuric acid (D₂SO₄)
Number of scans: 2,000

The powder X-ray diffraction measurement of the phthalocyanine pigment incorporated into the electrophotographic photosensitive member according to the present disclosure was performed under the following conditions.

### (Powder X-Ray Diffraction Measurement)

Used measurement apparatus: X-ray diffraction apparatus RINT-TTR II manufactured by Rigaku Corporation
X-ray tube bulb: Cu
X-ray wavelength: Kα1
Tube voltage: 50 KV
Tube current: 300 mA
Scan method: 2θ scan
Scan speed: 4.0°/min
Sampling interval: 0.020
Start angle 2θ: 5.0°
Stop angle 2θ: 35.0°
Goniometer: rotor horizontal goniometer (TTR-2)
Attachment: capillary rotating sample stage
Filter: none
Detector: scintillation counter
Incident monochromator: used
Slit: variable slit (parallel beam method)
Counter monochromator: not used
Divergence slit: open
Divergence vertical limit slit: 10.00 mm
Scattering slit: open
Light receiving slit: open

In the present disclosure, the charge-generating layer contains a hydroxygallium phthalocyanine crystal manufactured from the hydroxygallium phthalocyanine pigment to be used as the charge-generating substance.

The method of manufacturing a hydroxygallium phthalocyanine crystal according to the present disclosure includes: adding, to the hydroxygallium phthalocyanine pigment, the above-mentioned compound A and the above-mentioned compound B; and subjecting the mixture to the dispersion treatment by the wet milling system.

In the method of manufacturing a hydroxygallium phthalocyanine crystal according to the present disclosure, the mass ratio b2/a2 of the addition amount of the compound B to that of the compound A is preferably 2.6 to 26%. Herein, the mass ratio b2/a2 of the addition amount is the ratio of the mass of the above-mentioned compound B added to the hydroxygallium phthalocyanine pigment to the mass of the above-mentioned compound A added to the hydroxygallium phthalocyanine pigment.

The content of the charge-generating substance in the charge-generating layer is preferably 40 to 85 mass %, more preferably 60 to 80 mass % with respect to the total mass of the charge-generating layer.

Examples of the binder resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer has a thickness of preferably 0.1 to 1 μm, more preferably 0.15 to 0.4 km.

The charge-generating layer may be formed by preparing a coating liquid for a charge-generating layer containing the above-mentioned respective materials and a solvent, forming a coat thereof, and drying the coat. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge-Transporting Layer

The charge-transporting layer preferably contains the charge-transporting substance and a binder resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a substance having an ionization potential of 5.2 to 5.4 eV is preferred for obtaining the effect of the present application. When the ionization potential of the charge-transporting substance is 5.2 eV or more, a, which represents electric field intensity dependence, does not become too large, and hence the exacerbation of a memory phenomenon after repeated use of the electrophotographic photosensitive member can be suppressed. When the ionization potential is 5.4 eV or less, an increase in residual potential thereof can be suppressed.

The ionization potential may be determined by measuring threshold energy for the release of an electron through use of an atmospheric photoelectron spectrometer manufactured by Riken Keiki Co., Ltd. (product name: AC-2).

The content of the charge-transporting substance in the charge-transporting layer is preferably 25 to 70 mass %, more preferably 30 to 55 mass % with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably 4:10 to 20:10, more preferably 5:10 to 12:10.

In addition, the charge-transporting layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The charge-transporting layer has a thickness of preferably 5 to 30 μm, more preferably 8 to 17 μm, particularly preferably 10 to 14 μm.

The charge-transporting layer may be formed by preparing a coating liquid for a charge-transporting layer containing the above-mentioned respective materials and a solvent, forming a coat thereof, and drying the coat. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Single-Layer Photosensitive Layer

The single-layer photosensitive layer may be formed by preparing a coating liquid for a photosensitive layer containing the charge-generating substance, the charge-transporting substance, a resin, and a solvent, forming a coat thereof, and drying the coat. Examples of the charge-generating substance, the charge-transporting substance, and the resin are the same as the examples of the materials in the section “(1) Laminated Photosensitive Layer.”

### <Protective Layer>

In the present disclosure, a protective layer may be arranged on the photosensitive layer. The arrangement of the protective layer can improve the durability of the electrophotographic photosensitive member.

The protective layer preferably contains electroconductive particles and/or a charge-transporting substance, and a binder resin.

Examples of the electroconductive particles include particles of metal oxides, such as titanium oxide, zinc oxide, tin oxide, and indium oxide.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of these substances. Of those, a triarylamine compound and a benzidine compound are preferred.

Examples of the binder resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protective layer may be formed as a cured film by polymerizing a composition containing a monomer having a polymerizable functional group. As a reaction in this case, there are given, for example, a thermal polymerization reaction, a photopolymerization reaction, and a radiation polymerization reaction. Examples of the polymerizable functional group of the monomer having a polymerizable functional group include an acrylic group and a methacrylic group. A material having a charge-transporting ability may be used as the monomer having a polymerizable functional group.

The protective layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The protective layer has a thickness of preferably 0.5 to 10 μm, more preferably 1 to 7 μm.

The protective layer may be formed by preparing a coating liquid for a protective layer containing the above-mentioned respective materials and a solvent, forming a coat thereof, and drying and/or curing the coat. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

### [Process Cartridge and Electrophotographic Apparatus]

The process cartridge according to the present disclosure is characterized in that the process cartridge integrally supports the electrophotographic photosensitive member described above and at least one unit selected from the group consisting of: the charging unit; the developing unit; and the cleaning unit, and is detachably attachable to the main body of an electrophotographic apparatus.

In addition, the electrophotographic apparatus according to the present disclosure is characterized by including the electrophotographic photosensitive member described above, and the exposing unit, the charging unit, the developing unit, and the transferring unit.

An example of the schematic construction of an electrophotographic apparatus including a process cartridge including an electrophotographic photosensitive member is illustrated in FIGURE.

An electrophotographic photosensitive member 1 having a cylindrical shape is rotationally driven about a shaft 2 in a direction indicated by the arrow at a predetermined peripheral speed. The surface of the electrophotographic photosensitive member 1 is charged to a predetermined positive or negative potential by charging unit 3. Although a roller charging system based on a roller-type charging member is illustrated in the FIGURE, a charging system, such as a corona charging system, a contact charging system, or an injection charging system, may be adopted. The charged surface of the electrophotographic photosensitive member 1 is irradiated with exposure light 4 from exposing unit (not shown), and hence an electrostatic latent image corresponding to target image information is formed thereon. The electrostatic latent image formed on the surface of the electrophotographic photosensitive member 1 is developed with a toner stored in developing unit 5, and a toner image is formed on the surface of the electrophotographic photosensitive member 1. The toner image formed on the surface of the electrophotographic photosensitive member 1 is transferred onto a transfer material 7 by transferring unit 6. The transfer material 7 onto which the toner image has been transferred is conveyed to fixing unit 8, is subjected to treatment for fixing the toner image, and is printed out to the outside of the electrophotographic apparatus. The electrophotographic apparatus may include cleaning unit 9 for removing a deposit, such as the toner remaining on the surface of the electrophotographic photosensitive member 1 after the transfer. The cleaning unit 9 is preferably a cleaning blade containing a urethane resin. In addition, a so-called cleaner-less system, which removes the above-mentioned deposit with the developing unit 5 or the like without separate arrangement of the cleaning unit 9, may be used. The electrophotographic apparatus may include an electricity-removing mechanism that subjects the surface of the electrophotographic photosensitive member 1 to electricity-removing treatment with pre-exposure light 10 from pre-exposing unit (not shown). In addition, guiding unit 12, such as a rail, may be arranged for detachably attaching a process cartridge 11 according to one aspect of the present disclosure onto the main body of an electrophotographic image-forming apparatus.

The electrophotographic photosensitive member according to the present disclosure may be used in electrophotographic image-forming apparatus, such as a laser beam printer, an LED printer, a copying machine, a facsimile, and a multifunction peripheral thereof.

### EXAMPLES

The present disclosure is described in more detail below by way of Examples and Comparative Examples. The present disclosure is by no means limited to the following Examples, and various modifications may be made without departing from the gist of the present disclosure. In the description in the following Examples, “part(s)” is by mass unless otherwise specified.

### Example 1

### <Support>

An aluminum cylinder (JIS-A3003, aluminum alloy) having a diameter of 24 mm and a length of 257 mm was used as a support (electroconductive support).

### <Undercoat Layer>

The following materials were prepared.
Rutile-type titanium oxide particles (average primary particle diameter: 150 nm, manufactured by Tayca Corporation) 3 parts
N-methoxymethylated nylon (product name: TORESIN EF-30T, manufactured by Nagase ChemteX Corporation) 4.5 parts
Copolymerized nylon resin (product name: Amilan CM8000, manufactured by Toray Industries, Inc.) 1.5 parts

Those materials were added to a mixed solvent of 90 parts of methanol and 60 parts of 1-butanol to prepare a dispersion liquid. The dispersion liquid was subjected to dispersion treatment with a vertical sand mill using glass beads each having a diameter of 1.0 mm for 6 hours. The liquid subjected to the sand mill dispersion treatment as described above was then further subjected to dispersion treatment with an ultrasonic disperser (UT-205, manufactured by Sharp Corporation) for 1 hour to prepare a coating liquid for an undercoat layer. The output of the ultrasonic disperser was set to 100%. In addition, no media such as glass beads were used in this dispersion treatment.

Next, the resultant coating liquid for an undercoat layer was applied onto the above-mentioned support by dip coating to form a coat, and the coat was dried under heating at a temperature of 100° C. for 10 minutes to form an undercoat layer having a thickness of 2 μm.

### <Charge-Generating Layer>

### [Synthesis of Hydroxygallium Phthalocyanine Pigment]

### Synthesis Example 1

Under a nitrogen flow atmosphere, 5.46 parts of orthophthalonitrile and 45 parts of α-chloronaphthalene were loaded into a reaction kettle. After that, the mixture was heated so that its temperature was increased to 30° C., followed by the maintenance of the temperature. Next, 3.75 parts of gallium trichloride was loaded into the mixture at the temperature (30° C.). The moisture concentration of the mixed liquid at the time of the loading was 150 ppm. After that, the temperature of the mixed liquid was increased to 200° C. Next, under the nitrogen flow atmosphere, the mixed liquid was subjected to a reaction at a temperature of 200° C. for 4.5 hours, and was then cooled. The product was filtered when its temperature reached 150° C. The resultant filter residue was subjected to dispersion washing with N,N-dimethylformamide at a temperature of 140° C. for 2 hours, and was then filtered. The resultant filter residue was washed with methanol, and was then dried to provide a chlorogallium phthalocyanine pigment in a yield of 71%.

### Synthesis Example 2

4.65 Parts of the chlorogallium phthalocyanine pigment obtained in Synthesis Example 1 described above was dissolved in 139.5 parts of concentrated sulfuric acid at a temperature of 10° C., and the solution was dropped into 620 parts of ice water under stirring so that the pigment was reprecipitated, followed by filtration with a filter press under reduced pressure. At this time, No. 5C (manufactured by Advantec Toyo Kaisha, Ltd.) was used as a filter. The resultant wet cake (filter residue) was subjected to dispersion washing with 2% ammonia water for 30 minutes, and was then filtered with the filter press. Next, the resultant wet cake (filter residue) was subjected to dispersion washing with ion-exchanged water, and then its filtration with the filter press was repeated three times. Finally, the filter residue was freeze-dried to provide a hydroxygallium phthalocyanine pigment (hydrous hydroxygallium phthalocyanine pigment) having a solid content of 23% in a yield of 97%.

### Synthesis Example 3

6.6 Kilograms of the hydroxygallium phthalocyanine pigment obtained in Synthesis Example 2 described above was dried with a hyper-dry dryer (product name: HD-06R, frequency (oscillatory frequency): 2,455 MHz±15 MHz, manufactured by Biocon (Japan) Ltd.) as described below.

The hydroxygallium phthalocyanine pigment obtained in Synthesis Example 2 described above was mounted on a dedicated circular plastic tray under a block state (hydrous cake thickness: 4 cm or less) without being treated after its removal from the filter press, and the dryer was set as follows: a far-infrared ray was turned off, and the temperature of the inner wall of the dryer was set to 50° C. Then, at the time of microwave application, a vacuum pump and a leak valve were adjusted to adjust a vacuum degree in the dryer to 4.0 to 10.0 kPa.

First, as a first step, a microwave having an output of 4.8 kW was applied to the hydroxygallium phthalocyanine pigment for 50 minutes. Next, the microwave was turned off once, and the leak valve was closed once to establish a high vacuum of 2 kPa or less. The solid content of the hydroxygallium phthalocyanine pigment at this time point was 88%. As a second step, the leak valve was adjusted to adjust the vacuum degree (pressure in the dryer) within the above-mentioned preset value range (4.0 to 10.0 kPa). After that, a microwave having an output of 1.2 kW was applied to the hydroxygallium phthalocyanine pigment for 5 minutes. In addition, the microwave was turned off once, and the leak valve was closed once to establish a high vacuum of 2 kPa or less. The second step was further repeated once (a total of twice). The solid content of the hydroxygallium phthalocyanine pigment at this time point was 98%. Further, as a third step, microwave application was performed in the same manner as in the second step except that the output of the microwave in the second step was changed from 1.2 to 0.8 kW. The third step was further repeated once (a total of twice). Further, as a fourth step, the leak valve was adjusted to return the vacuum degree (pressure in the dryer) within the above-mentioned preset value range (4.0 to 10.0 kPa). After that, a microwave having an output of 0.4 kW was applied to the hydroxygallium phthalocyanine pigment for 3 minutes. In addition, the microwave was turned off once, and the leak valve was closed once to establish a high vacuum of 2 kPa or less. The fourth step was further repeated seven times (a total of eight times). Thus, 1.52 kg of a hydroxygallium phthalocyanine pigment (crystal) having a water content of 1% or less was obtained over a total of 3 hours. [Preparation Example of Coating Liquid 1 for Charge-generating Layer]

The following materials were prepared.
Hydroxygallium phthalocyanine pigment obtained in Synthesis Example 3 described above 20 parts
N-methylformamide serving as compound A172 parts
Toluene serving as compound B18 parts

Those materials were subjected to wet milling treatment in a sand mill at 25±5° C. for 70 hours with 300 parts of glass beads having an average particle diameter of 0.8 mm. At this time, a 1 L sand mill was used as a container, and the wet milling treatment was performed under such a condition that its blades each rotated 600 times in 1 minute. The hydroxygallium phthalocyanine crystal was taken out from the dispersion liquid with N-methylformamide, and was then filtered, and the residue on the filter was sufficiently washed with tetrahydrofuran. The filtered product was vacuum-dried to provide 18 parts of a hydroxygallium phthalocyanine crystal. The hydroxygallium phthalocyanine crystal was a crystal showing peaks at 7.4° and 28.3° in an X-ray diffraction pattern (Bragg angle 2θ±0.2°) using CuKα rays.

In addition, it was observed by NMR measurement that the hydroxygallium phthalocyanine crystal obtained in this Example contained N-methylformamide at 2.00 mass % and toluene at 0.41 mass %, the contents being converted from proton ratios. Because both N-methylformamide and toluene are soluble in tetrahydrofuran serving as a washing solvent described above, it is understood that N-methylformamide and toluene are incorporated into the hydroxygallium phthalocyanine crystal in this Example.

Next, the following materials were prepared.
Hydroxygallium phthalocyanine crystal obtained above 20 parts
Polyvinyl butyral (product name: S-LEC BX-1, manufactured by Sekisui Chemical Company, Limited) 10 parts
Cyclohexanone 190 parts
Glass beads each having a diameter of 0.9 mm482 parts

Those materials were subjected to dispersion treatment with a sand mill (K-800, manufactured by Igarashi Machine Production Co., Ltd. (currently AIMEX Co., Ltd.), disc diameter: 70 mm, number of discs: 5) under a cooling water temperature of 18° C. for 4 hours. At this time, the treatment was performed under such a condition that the discs each rotated 1,800 times in 1 minute. 444 Parts of cyclohexanone and 634 parts of ethyl acetate were added to the dispersion liquid to prepare a coating liquid 1 for a charge-generating layer.

The coating liquid 1 for a charge-generating layer obtained in the above-mentioned preparation example of the coating liquid 1 for a charge-generating layer was applied onto the above-mentioned undercoat layer by dip coating to form a coat, and the coat was dried under heating at a temperature of 100° C. for 10 minutes to form a charge-generating layer having a thickness of 0.2 μm.

### <Charge-Transporting Layer>

The following materials were prepared.
Triarylamine compound represented by the following formula serving as a charge-transporting substance 5 parts

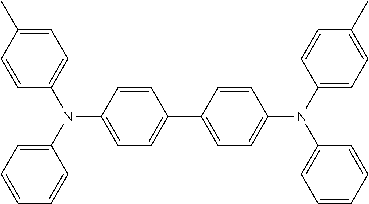 [SMILES: Cc1ccc(N(c2ccccc2)c2ccc(-c3ccc(N(c4ccccc4)c4ccc(C)cc4)cc3)cc2)cc1]

Triarylamine compound represented by the following formula serving as a charge-transporting substance 5 parts

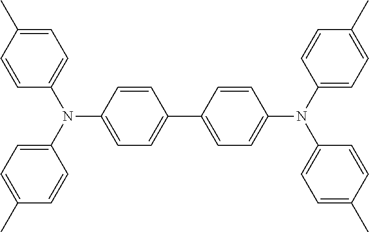 [SMILES: Cc1ccc(N(c2ccc(C)cc2)c2ccc(-c3ccc(N(c4ccc(C)cc4)c4ccc(C)cc4)cc3)cc2)cc1]

Polycarbonate resin (product name: Iupilon Z-400, manufactured by Mitsubishi Engineering-Plastics Corporation) 10 parts

Those materials were dissolved in a mixed solvent of 25 parts of orthoxylene, 25 parts of methyl benzoate, and 25 parts of dimethoxymethane to prepare a coating liquid 1 for a charge-transporting layer.

Next, the resultant coating liquid for a charge-transporting layer was applied onto the charge-generating layer by dip coating to form a coat, and the coat was dried at 120° C. for 30 minutes to form a charge-transporting layer having a thickness of 16 μm.

An electrophotographic photosensitive member 1 was manufactured by the above-mentioned method.

### [Coating Liquids 2 to 35 for Charge-Generating Layers]

Coating liquids 2 to 35 for charge-generating layers were each manufactured in the same manner as in the coating liquid 1 for a charge-generating layer except that in the preparation example of the coating liquid 1 for a charge-generating layer, the kinds of the compound A and the compound B, and the contents thereof in the crystal were changed to substances and values shown in Tables 1-1 to 1-3, respectively.

The meanings of abbreviations for the kinds of the compound A and the compound B in Tables 1-1 to 1-3 are as described below.
NMF: N-methylformamide
DMF: N,N-dimethylformamide
EtOAc: ethyl acetate
THF: tetrahydrofuran
NMP: N-methyl-2-pyrrolidone
W: water

In addition, the addition ratio (%) b2/a2 in Tables 1-1 to 1-3 refers to the ratio of the mass of the compound B added to the hydroxygallium phthalocyanine pigment to the mass of the compound A added to the hydroxygallium phthalocyanine pigment in the preparation of the coating liquid for a charge-generating layer.

In addition, the ratio b/a in Tables 1-1 to 1-3 refers to the mass ratio of the compound B to the compound A in the hydroxygallium phthalocyanine crystal. In addition, the a/p in Tables 1-1 to 1-3 refers to the mass ratio of the compound A to the entirety of the hydroxygallium phthalocyanine crystal in the hydroxygallium phthalocyanine crystal. In addition, the ratio b/p in Tables 1-1 to 1-3 refers to the mass ratio of the compound A to the entirety of the hydroxygallium phthalocyanine crystal in the hydroxygallium phthalocyanine crystal.

A water content in the pigment in the coating liquid 35 for a charge-generating layer was measured as described below by a water vaporization Karl Fischer method. First, 0.3 g of the pigment in the coating liquid 35 for a charge-generating layer was heated to 180° C. in a water vaporization apparatus (ADP-611, manufactured by Kyoto Electronics Manufacturing Co., Ltd.) so that its water was evaporated. Subsequently, the water content was determined by coulometric titration using a Karl Fischer reagent with a trace moisture measurement apparatus (MKC-501, manufactured by Kyoto Electronics Manufacturing Co., Ltd.).

### Examples 2 to 32 and Comparative Examples 1 to 3

Electrophotographic photosensitive members were each manufactured in the same manner as in Example 1 except that the kind of the coating liquid for a charge-generating layer used for forming the charge-generating layer was changed as shown in Tables 1-1 to 1-3.

### [Evaluation]

The environmental humidity dependence of the potential of an exposed portion was evaluated under the following conditions by using each of the electrophotographic photosensitive members manufactured in Examples 1 to 32 and Comparative Examples 1 to 3.

A reconstructed machine of a laser beam printer available under the product name “HP LaserJet Enterprise Color M553dn” from Hewlett-Packard Company was used as an electrophotographic apparatus. Specific reconstructions were as follows: a printing process speed was changed to 80 (sheets/min); and the printer was changed so that the adjustment and measurement of a voltage to be applied to its charging roller, and the adjustment and measurement of an image exposure light quantity were able to be performed.

A reconstructed product of a cartridge for the laser beam printer available under the product name “HP LaserJet Enterprise Color M553dn” from Hewlett-Packard Company was used as a cartridge for evaluation. A specific reconstruction was as follows: a potential probe (product name: model 6000B-8, manufactured by Trek Japan Co., Ltd.) was attached at the developing position of the cartridge so that the potential was able to be measured.

First, the above-mentioned electrophotographic apparatus, the above-mentioned cartridge, and each of the electrophotographic photosensitive members according to Examples and Comparative Examples were left to stand in an environment at a temperature of 23° C. and a humidity of 50% RH for 24 hours or more. After that, the electrophotographic photosensitive member was mounted in the cartridge, and the resultant was attached to the electrophotographic apparatus.

Next, the potential of the exposed portion was measured under the following conditions. As a charging condition, a charging portion potential was −600 V, and as an exposure condition, the image exposure light quantity was adjusted to 0.4 μJ/cm². The resultant potential of the exposed portion was defined as V1.

The above-mentioned electrophotographic apparatus, the above-mentioned cartridge, and each of the electrophotographic photosensitive members of Examples and Comparative Examples were left to stand in an environment at a temperature of 23° C. and a humidity of 85% RH for 24 hours or more. After that, the electrophotographic photosensitive member was mounted in the cartridge, and the resultant was attached to the electrophotographic apparatus.

Next, the potential of the exposed portion was measured under the same conditions as those at the time of the measurement of the V1. The resultant potential of the exposed portion was defined as V2.

Finally, a change Δ in potential of the exposed portion was determined from the resultant V1 and V2 based on the following equation.

$$Δ = \vert V 2 - V 1 \vert$$

The results of the above-mentioned evaluation using the electrophotographic photosensitive members manufactured in Examples 1 to 32 and Comparative Examples 1 to 3 are shown in Tables 1-1 to 1-3. As can be seen from Tables 1-1 to 1-3, in each of Examples 1 to 32, the absolute value of the potential of the exposed portion is low, and a fluctuation in potential of the exposed portion is suppressed even when the humidity of the environment where the electrophotographic apparatus is used increases.

TABLE 1-1

| Example/ | Number of coating | Compound A | | |
|---|---|---|---|---|
| Comparative | liquid for charge- | | Dipole | SP value |
| Example | generating layer | Kind | moment (D) | (cal/cm³)^{1/2} |
| Example 1 | 1 | NMF | 3.86 | 14.2 |
| Example 2 | 2 | NMF | 3.86 | 14.2 |
| Example 3 | 3 | NMF | 3.86 | 14.2 |
| Example 4 | 4 | NMF | 3.86 | 14.2 |
| Example 5 | 5 | NMF | 3.86 | 14.2 |
| Example 6 | 6 | NMF | 3.86 | 14.2 |
| Example 7 | 7 | NMF | 3.86 | 14.2 |
| Example 8 | 8 | NMF | 3.86 | 14.2 |
| Example 9 | 9 | NMF | 3.86 | 14.2 |
| Example 10 | 10 | NMF | 3.86 | 14.2 |
| Example 11 | 11 | NMF | 3.86 | 14.2 |
| Example 12 | 12 | NMF | 3.86 | 14.2 |
| Example 13 | 13 | NMF | 3.86 | 14.2 |
| Example 14 | 14 | NMF | 3.86 | 14.2 |
| Example 15 | 15 | NMF | 3.86 | 14.2 |
| Example 16 | 16 | NMF | 3.86 | 14.2 |
| Example 17 | 17 | NMF | 3.86 | 14.2 |
| Example 18 | 18 | DMF | 3.93 | 11.8 |
| Example 19 | 19 | DMF | 3.93 | 11.8 |
| Example 20 | 20 | DMF | 3.93 | 11.8 |
| Example 21 | 21 | DMF | 3.93 | 11.8 |
| Example 22 | 22 | DMF | 3.93 | 11.8 |
| Example 23 | 23 | DMF | 3.93 | 11.8 |
| Example 24 | 24 | DMF | 3.93 | 11.8 |
| Example 25 | 25 | DMF | 3.93 | 11.8 |
| Example 26 | 26 | DMF | 3.93 | 11.8 |
| Example 27 | 27 | DMF | 3.93 | 11.8 |
| Example 28 | 28 | DMF | 3.93 | 11.8 |
| Example 29 | 29 | DMF | 3.93 | 11.8 |
| Example 30 | 30 | DMF | 3.93 | 11.8 |
| Example 31 | 31 | DMF | 3.93 | 11.8 |
| Example 32 | 32 | DMF | 3.93 | 11.8 |
| Comparative | 33 | NMF | 3.86 | 14.2 |
| Example 1 | | | | |
| Comparative | 34 | DMF | 3.93 | 11.8 |
| Example 2 | | | | |
| Comparative | 35 | NMP | 4.09 | 11.3 |
| Example 3 | | | | |

TABLE 1-2

| Example/ | Compound B | | | Addition |
|---|---|---|---|---|
| Comparative | | Dipole | SP value | ratio (%) |
| Example | Kind | moment (D) | (cal/cm³)^{1/2} | b2/a2 |
| Example 1 | Toluene | 0.4 | 8.9 | 11 |
| Example 2 | Toluene | 0.4 | 8.9 | 10 |
| Example 3 | Toluene | 0.4 | 8.9 | 2.8 |
| Example 4 | Toluene | 0.4 | 8.9 | 7.7 |
| Example 5 | Toluene | 0.4 | 8.9 | 26 |
| Example 6 | Toluene | 0.4 | 8.9 | 24 |
| Example 7 | Toluene | 0.4 | 8.9 | 29 |
| Example 8 | EtOAc | 1.8 | 9.1 | 12 |
| Example 9 | EtOAc | 1.8 | 9.1 | 2.4 |
| Example 10 | EtOAc | 1.8 | 9.1 | 8.1 |
| Example 11 | EtOAc | 1.8 | 9.1 | 27 |
| Example 12 | EtOAc | 1.8 | 9.1 | 32 |
| Example 13 | THF | 1.6 | 9.5 | 12 |
| Example 14 | THF | 1.6 | 9.5 | 2.6 |
| Example 15 | THE | 1.6 | 9.5 | 7.3 |
| Example 16 | THF | 1.6 | 9.5 | 28 |
| Example 17 | THF | 1.6 | 9.5 | 32 |
| Example 18 | Toluene | 0.4 | 8.9 | 10 |
| Example 19 | Toluene | 0.4 | 8.9 | 2.6 |
| Example 20 | Toluene | 0.4 | 8.9 | 7.7 |
| Example 21 | Toluene | 0.4 | 8.9 | 29 |
| Example 22 | Toluene | 0.4 | 8.9 | 32 |
| Example 23 | EtOAc | 1.8 | 9.1 | 12 |
| Example 24 | EtOAc | 1.8 | 9.1 | 2.4 |
| Example 25 | EtOAc | 1.8 | 9.1 | 8.1 |
| Example 26 | EtOAc | 1.8 | 9.1 | 28 |
| Example 27 | EtOAc | 1.8 | 9.1 | 32 |
| Example 28 | THF | 1.6 | 9.5 | 12 |
| Example 29 | THF | 1.6 | 9.5 | 2.8 |
| Example 30 | THF | 1.6 | 9.5 | 7.5 |
| Example 31 | THF | 1.6 | 9.5 | 28 |
| Example 32 | THF | 1.6 | 9.5 | 33 |
| Comparative | — | — | — | — |
| Example 1 | | | | |
| Comparative | — | — | — | — |
| Example 2 | | | | |
| Comparative | W | 1.9 | 23.4 | 11 |
| Example 3 | | | | |

TABLE 1-3

| Example/ | Content ratio in crystal (%) | | | Evaluation | |
|---|---|---|---|---|---|
| Comparative Example | b/a | a/p | b/p | V1 (−V) | Δ(V) |
| Example 1 | 21 | 2.00 | 0.41 | 50.4 | 9.0 |
| Example 2 | 20 | 0.50 | 0.10 | 80.6 | 12.0 |
| Example 3 | 5.6 | 1.80 | 0.10 | 50.4 | 12.5 |
| Example 4 | 15 | 2.00 | 0.30 | 55.4 | 9.8 |
| Example 5 | 50 | 2.00 | 1.00 | 56.4 | 10.2 |
| Example 6 | 47 | 3.00 | 1.40 | 90.7 | 10.8 |
| Example 7 | 57 | 3.50 | 2.00 | 95.7 | 12.6 |
| Example 8 | 23 | 2.00 | 0.45 | 61.0 | 11.2 |
| Example 9 | 4.8 | 2.10 | 0.10 | 77.6 | 14.3 |
| Example 10 | 16 | 1.90 | 0.30 | 55.4 | 11.7 |
| Example 11 | 52 | 2.10 | 1.10 | 78.6 | 12.8 |
| Example 12 | 63 | 2.00 | 1.26 | 62.0 | 13.2 |
| Example 13 | 24 | 2.10 | 0.48 | 84.7 | 11.1 |
| Example 14 | 5.0 | 2.00 | 0.10 | 66.5 | 12.1 |
| Example 15 | 14 | 2.10 | 0.30 | 83.7 | 11.6 |
| Example 16 | 54 | 2.00 | 1.08 | 67.5 | 12.8 |
| Example 17 | 63 | 2.00 | 1.26 | 68.0 | 13.2 |
| Example 18 | 20 | 2.0 | 0.40 | 83.1 | 12.0 |
| Example 19 | 5.1 | 1.95 | 0.10 | 75.6 | 13.0 |
| Example 20 | 15 | 2.00 | 0.30 | 82.1 | 12.5 |
| Example 21 | 57 | 1.96 | 1.11 | 76.6 | 13.3 |
| Example 22 | 63 | 2.00 | 1.26 | 84.1 | 13.5 |
| Example 23 | 23 | 1.98 | 0.45 | 91.4 | 16.4 |
| Example 24 | 4.8 | 2.10 | 0.10 | 116.4 | 18.1 |
| Example 25 | 16 | 1.90 | 0.30 | 83.1 | 16.8 |
| Example 26 | 55 | 2.00 | 1.10 | 92.4 | 21.6 |
| Example 27 | 63 | 2.00 | 1.26 | 93.0 | 23.1 |
| Example 28 | 24 | 2.00 | 0.48 | 99.7 | 16.9 |
| Example 29 | 5.5 | 2.00 | 0.11 | 98.7 | 18.5 |
| Example 30 | 15 | 2.10 | 0.31 | 127.0 | 17.1 |
| Example 31 | 54 | 2.0 | 1.08 | 100.0 | 22.0 |
| Example 32 | 65 | 1.95 | 1.27 | 94.4 | 23.5 |
| Comparative | — | 2.0 | — | 55.0 | 40.0 |
| Example 1 | | | | | |
| Comparative | — | 2.10 | — | 75.0 | 41.0 |
| Example 2 | | | | | |
| Comparative | 21 | 2.00 | 0.38 | 300.0 | 83.0 |
| Example 3 | | | | | |

According to the present disclosure, there can be provided such electrophotographic photosensitive member that even in an electrophotographic apparatus for a high-speed printing process, the absolute value of the potential of the exposed portion is low, and the potential of the exposed portion is highly stable without being affected by a fluctuation in humidity of an environment where the electrophotographic apparatus is used.

The present disclosure is not limited to the embodiments described above, and various changes and modifications may be made without departing from the spirit and scope of the present disclosure. Accordingly, the following claims are appended hereto in order to make the scope of the present disclosure public.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic photosensitive member comprising:
a support; and
a photosensitive layer,
wherein the photosensitive layer contains a hydroxygallium phthalocyanine crystal,
wherein the hydroxygallium phthalocyanine crystal contains:
a compound A having a dipole moment magnitude of 3.6 D or more and an SP value SPA of 11.5 (cal/cm3)½ or more; and
a compound B having a dipole moment magnitude of more than 0 to 2.0 D and an SP value SPB of 9.5 (cal/cm3)½ or less, and
wherein a mass ratio b/a of the compound B to the compound A in the hydroxygallium phthalocyanine crystal is 5.0 to 50%.

2. The electrophotographic photosensitive member according to claim 1, wherein a difference ΔSP between the SPA and the SPB is 2.5 (cal/cm3)½ or more.

3. The electrophotographic photosensitive member according to claim 1, wherein the mass ratio b/a is 10 to 24%.

4. The electrophotographic photosensitive member according to claim 1, wherein a mass ratio a/p of the compound A to an entirety of the hydroxygallium phthalocyanine crystal in the hydroxygallium phthalocyanine crystal is 0.50 to 3.50%.

5. The electrophotographic photosensitive member according to claim 4, wherein the mass ratio a/p is 1.80 to 3.00%.

6. The electrophotographic photosensitive member according to claim 1, wherein a mass ratio b/p of the compound B to an entirety of the hydroxygallium phthalocyanine crystal in the hydroxygallium phthalocyanine crystal is 0.10 to 2.00%.

7. The electrophotographic photosensitive member according to claim 6, wherein the mass ratio b/p is 0.20 to 0.50%.

8. The electrophotographic photosensitive member according to claim 1, wherein the compound A has an amide group.

9. The electrophotographic photosensitive member according to claim 1, wherein the compound A is at least one selected from the group consisting of: N,N-dimethylformamide; and N-methylformamide.

10. The electrophotographic photosensitive member according to claim 1, wherein the compound B is at least one selected from the group consisting of: toluene; ethyl acetate; and tetrahydrofuran.

11. A process cartridge comprising:
an electrophotographic photosensitive member; and
at least one unit selected from the group consisting of: charging unit; developing unit; and cleaning unit,
the process cartridge integrally supporting the electrophotographic photosensitive member and the at least one unit, and being detachably attachable to a main body of an electrophotographic apparatus, and
the electrophotographic photosensitive member comprising:
a support; and
a photosensitive layer,
wherein the photosensitive layer contains a hydroxygallium phthalocyanine crystal,
wherein the hydroxygallium phthalocyanine crystal contains:
a compound A having a dipole moment magnitude of 3.6 D or more and an SP value SPA of 11.5 (cal/cm3)½ or more; and
a compound B having a dipole moment magnitude of more than 0 to 2.0 D and an SP value SPB of 9.5 (cal/cm3)½ or less, and
wherein a mass ratio b/a of the compound B to the compound A in the hydroxygallium phthalocyanine crystal is 5.0 to 50%.

12. An electrophotographic apparatus comprising:
an electrophotographic photosensitive member; and
at least one unit selected from the group consisting of: exposing unit; charging unit; developing unit; transferring unit; and cleaning unit,
the electrophotographic photosensitive member comprising:
a support; and
a photosensitive layer,
wherein the photosensitive layer contains a hydroxygallium phthalocyanine crystal,
wherein the hydroxygallium phthalocyanine crystal contains:
a compound A having a dipole moment magnitude of 3.6 D or more and an SP value SPA of 11.5 (cal/cm3)½ or more; and
a compound B having a dipole moment magnitude of more than 0 to 2.0 D and an SP value SPB of 9.5 (cal/cm3)½ or less, and
wherein a mass ratio b/a of the compound B to the compound A in the hydroxygallium phthalocyanine crystal is 5.0 to 50%.
